(19) United States
(12) Patent Application Publication
(10) Pub. No.: US 2024/0113873 A1
(43) Pub. Date: Apr. 4, 2024

(54) DATA PLATFORM USER KEY-ROTATOR

(71) Applicant: Snowflake Inc., Bozeman, MT (US)

(72) Inventors: Ryan M. Bacastow, Chicago, IL (US); Brett L. Baloun, Naperville, IL (US); Brian Tyler White, Cataula, GA (US)

(21) Appl. No.: 17/937,020

(22) Filed: Sep. 30, 2022

(51) Int. Cl. H04L 9/08

(52) U.S. Cl. CPC H04L 9/0891; H04L 9/0825; H04L 9/0894

(57) ABSTRACT

A system for key-rotation in a data platform. A computing system receives key-rotator application configuration instructions and generates a key-rotator application based on the key key-rotator application configuration instructions. A key-rotation process using the key-rotation application is initiated based on a predetermined schedule where the key-rotation process includes accessing a data platform based on an account identification of the key-rotator application configuration instructions, determining a private key and public key, storing the private key and the public key in a datastore, assigning the public key to a user profile of the data platform where the user profile included in the key-rotator application configuration instructions, updating one or more data platform services with the private key, and deleting a prior public key from the user profile.

### TECHNICAL FIELD

Examples of the disclosure relate generally to databases and, more specifically, to security of shared applications.

### BACKGROUND

Data platforms are widely used for data storage and data access in computing and communication contexts. With respect to architecture, a data platform could be an on-premises data platform, a network-based data platform (e.g., a cloud-based data platform), a combination of the two, and/or include another type of architecture. With respect to type of data processing, a data platform could implement online transactional processing (OLTP), online analytical processing (OLAP), a combination of the two, and/or another type of data processing. Moreover, a data platform could be or include a relational database management system (RDBMS) and/or one or more other types of database management systems.

### BRIEF DESCRIPTION OF THE DRAWINGS

The present disclosure will be understood more fully from the detailed description given below and from the accompanying drawings of various examples of the disclosure.

FIG. 1 illustrates an example computing environment that includes a network-based data platform in communication with a cloud storage provider system, in accordance with some examples of the present disclosure.

FIG. 2 is a block diagram illustrating components of a compute service manager, in accordance with some examples of the present disclosure.

FIG. 3 is a block diagram illustrating components of an execution platform, in accordance with some examples of the present disclosure.

FIG. 4A is a process flow diagram illustrating a key-rotation management method in accordance with some examples of the present disclosure.

FIG. 4B illustrates a computing environment of a key-rotation management process in accordance with some examples of the present disclosure.

FIG. 4C illustrates a portion of a user interface of a key-rotation management process in accordance with some examples of the present disclosure.

FIG. 4D illustrates another portion of a user interface of a key-rotation management process in accordance with some examples of the present disclosure.

FIG. 4E illustrates another portion of a user interface of a key-rotation management process in accordance with some examples of the present disclosure.

FIG. 5 illustrates a diagrammatic representation of a machine in the form of a computer system within which a set of instructions may be executed for causing the machine to perform any one or more of the methodologies discussed herein, in accordance with some examples of the present disclosure.

### DETAILED DESCRIPTION

A data platform provider may offer various methods for user authentication. Basic authentication (username and password) suffers from being susceptible to brute force attacks and attacks based on social engineering. Key pair authentication (KPA) is more secure than basic authentication as it is computationally difficult to generate solutions through brute force approaches and key pairs are not human generated. Single sign-on (SSO), and OAuth processes also provide enhanced security as compared to basic authentication. Multi-factor authentication (MFA) can be used to enhance the security provided by some of these methods that do not already incorporate some form of multiple factor, such as key pairs.

Key pair authentication may be supported for enhanced security as an alternative to basic authentication. This authentication method uses a 2048-bit RSA key pair. Rotation of public keys is supported to help meet cryptographic best practices by offering multiple public key slots per user. This authentication method is commonly utilized for service users or non-human users authenticating to execute programmatic tasks. The public key is then assigned to the data platform user who uses a data platform client to connect and authenticate to the data platform. The customer is responsible for initiating generation of these keys, storing and securing them, and managing the rotation schedule and process. In many scenarios, because of increased security posture, these secrets are stored using secret management tools.

User key pair authentication and rotation can be a significant pain point for customers, often requiring considerable programmatic experience to create a do-it-yourself framework. A key-rotation application and library creates an application programming interface (API) and a front-end application that automates key rotation. A front-end application builds on top of a data platform access programming utility which allows users to quickly get started with generating and rotating keys using a local file system or persisting these keys to the currently supported secret managers.

Reference will now be made in detail to specific examples for carrying out the inventive subject matter. Examples of these specific examples are illustrated in the accompanying drawings, and specific details are set forth in the following description in order to provide a thorough understanding of the subject matter. It will be understood that these examples are not intended to limit the scope of the claims to the illustrated examples. On the contrary, they are intended to cover such alternatives, modifications, and equivalents as may be included within the scope of the disclosure.

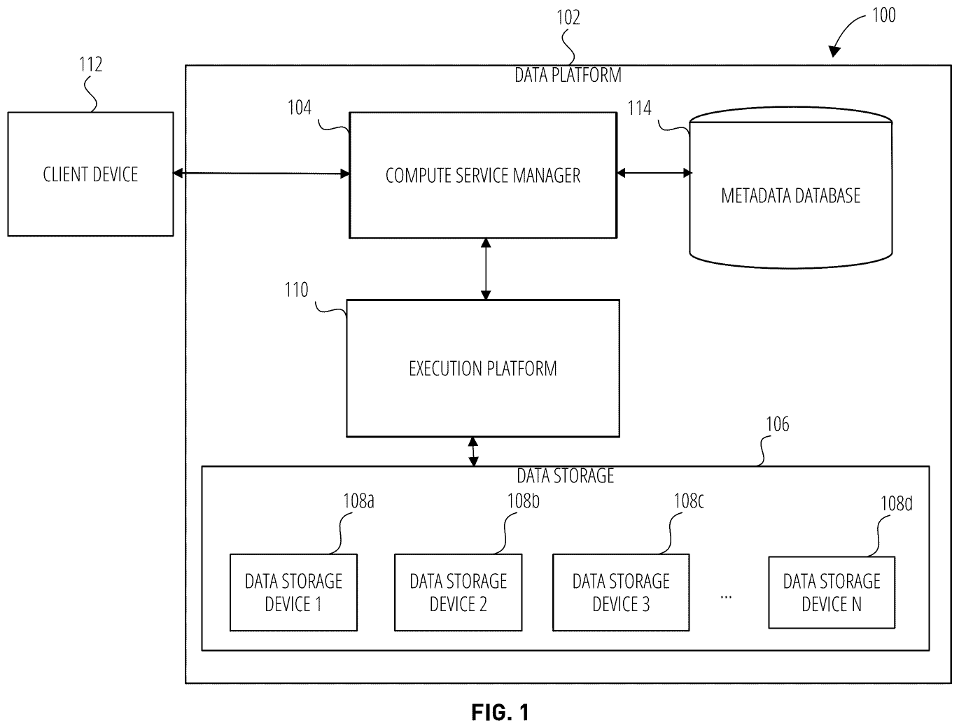

FIG. 1 illustrates an example computing environment 100 that includes a data platform 102 in communication with a client device 112, in accordance with some examples of the present disclosure. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not specifically described herein.

As shown, the data platform 102 comprises a data storage 106, a compute service manager 104, an execution platform 110, and a metadata database 114. The data storage 106 comprises a plurality of computing machines and provides on-demand computer system resources such as data storage and computing power to the data platform 102. As shown, the data storage 106 comprises multiple data storage devices, such as data storage device 1 108a, data storage device 2 108b, data storage device 3 108c, and data storage device N 108d. In some examples, the data storage devices 1 to N are cloud-based storage devices located in one or more geographic locations. For example, the data storage devices 1 to N may be part of a public cloud infrastructure or a private cloud infrastructure. The data storage devices 1 to N may be hard disk drives (HDDs), solid state drives (SSDs), storage clusters, Amazon S3™ storage systems or any other data storage technology. Additionally, the data storage 106 may include distributed file systems (e.g., Hadoop Distributed File Systems (HDFS)), object storage systems, and the like.

The data platform 102 is used for reporting and analysis of integrated data from one or more disparate sources including the storage devices 1 to N within the data storage 106. The data platform 102 hosts and provides data reporting and analysis services to multiple consumer accounts. Administrative users can create and manage identities (e.g., users, roles, and groups) and use privileges to allow or deny access to identities to resources and services. Generally, the data platform 102 maintains numerous consumer accounts for numerous respective consumers. The data platform 102 maintains each consumer account in one or more storage devices of the data storage 106. Moreover, the data platform 102 may maintain metadata associated with the consumer accounts in the metadata database 114. Each consumer account includes multiple data objects with examples including users, roles, privileges, a datastores or other data locations (herein termed a “stage” or “stages”), and the like.

The compute service manager 104 coordinates and manages operations of the data platform 102. The compute service manager 104 also performs query optimization and compilation as well as managing clusters of compute services that provide compute resources (also referred to as “virtual warehouses”). The compute service manager 104 can support any number and type of clients such as end users providing data storage and retrieval requests, system administrators managing the systems and methods described herein, and other components/devices that interact with compute service manager 104. As an example, the compute service manager 104 is in communication with the client device 112. The client device 112 can be used by a user of one of the multiple consumer accounts supported by the data platform 102 to interact with and utilize the functionality of the data platform 102. In some examples, the compute service manager 104 does not receive any direct communications from the client device 112 and only receives communications concerning jobs from a queue within the data platform 102.

The compute service manager 104 is also coupled to metadata database 114. The metadata database 114 stores data pertaining to various functions and aspects associated with the data platform 102 and its users. In some examples, the metadata database 114 includes a summary of data stored in remote data storage systems as well as data available from a local cache. In some examples, the metadata database 114 may include information regarding how data is organized in remote data storage systems (e.g., the database storage 106) and the local caches. In some examples, the metadata database 114 include data of metrics describing usage and access by providers and consumers of the data stored on the data platform 102. In some examples, the metadata database 114 allows systems and services to determine whether a piece of data needs to be accessed without loading or accessing the actual data from a storage device.

The compute service manager 104 is further coupled to the execution platform 110, which provides multiple computing resources that execute various data storage and data retrieval tasks. The execution platform 110 is coupled to the database storage 106. The execution platform 110 comprises a plurality of compute nodes. A set of processes on a compute node executes a query plan compiled by the compute service manager 104. The set of processes can include: a first process to execute the query plan; a second process to monitor and delete micro-partition files using a least recently used (LRU) policy and implement an out of memory (OOM) error mitigation process; a third process that extracts health information from process logs and status to send back to the compute service manager 104; a fourth process to establish communication with the compute service manager 104 after a system boot; and a fifth process to handle all communication with a compute cluster for a given job provided by the compute service manager 104 and to communicate information back to the compute service manager 104 and other compute nodes of the execution platform 110.

In some examples, communication links between elements of the computing environment 100 are implemented via one or more data communication networks. These data communication networks may utilize any communication protocol and any type of communication medium. In some examples, the data communication networks are a combination of two or more data communication networks (or sub-networks) coupled to one another. In alternate examples, these communication links are implemented using any type of communication medium and any communication protocol.

As shown in FIG. 1, the data storage devices data storage device 1 108a to data storage device N 108d are decoupled from the computing resources associated with the execution platform 110. This architecture supports dynamic changes to the data platform 102 based on the changing data storage/retrieval needs as well as the changing needs of the users and systems. The support of dynamic changes allows the data platform 102 to scale quickly in response to changing demands on the systems and components within the data platform 102. The decoupling of the computing resources from the data storage devices supports the storage of large amounts of data without requiring a corresponding large amount of computing resources. Similarly, this decoupling of resources supports a significant increase in the computing resources utilized at a particular time without requiring a corresponding increase in the available data storage resources.

The compute service manager 104, metadata database 114, execution platform 110, and data storage 106 are shown in FIG. 1 as individual discrete components. However, each of the compute service manager 104, metadata database 114, execution platform 110, and data storage 106 may be implemented as a distributed system (e.g., distributed across multiple systems/platforms at multiple geographic locations). Additionally, each of the compute service manager 104, metadata database 114, execution platform 110, and data storage 106 can be scaled up or down (independently of one another) depending on changes to the requests received and the changing needs of the data platform 102. Thus, in the described examples, the data platform 102 is dynamic and supports regular changes to meet the current data processing needs.

During operation, the data platform 102 processes multiple jobs determined by the compute service manager 104. These jobs are scheduled and managed by the compute service manager 104 to determine when and how to execute the job. For example, the compute service manager 104 may divide the job into multiple discrete tasks and may determine what data is needed to execute each of the multiple discrete tasks. The compute service manager 104 may assign each of the multiple discrete tasks to one or more nodes of the execution platform 110 to process the task. The compute service manager 104 may determine what data is needed to process a task and further determine which nodes within the execution platform 110 are best suited to process the task. Some nodes may have already cached the data needed to process the task and, therefore, be a good candidate for processing the task. Metadata stored in the metadata database 114 assists the compute service manager 104 in determining which nodes in the execution platform 110 have already cached at least a portion of the data needed to process the task. One or more nodes in the execution platform 110 process the task using data cached by the nodes and, if necessary, data retrieved from the data storage 106. It is desirable to retrieve as much data as possible from caches within the execution platform 110 because the retrieval speed is typically faster than retrieving data from the data storage 106.

As shown in FIG. 1, the computing environment 100 separates the execution platform 110 from the data storage 106. In this arrangement, the processing resources and cache resources in the execution platform 110 operate independently of the database storage devices data storage device 1 108a to data storage device N 108d in the data storage 106. Thus, the computing resources and cache resources are not restricted to a specific one of the data storage device 1 108a to data storage device N 108d. Instead, all computing resources and all cache resources may retrieve data from, and store data to, any of the data storage resources in the data storage 106.

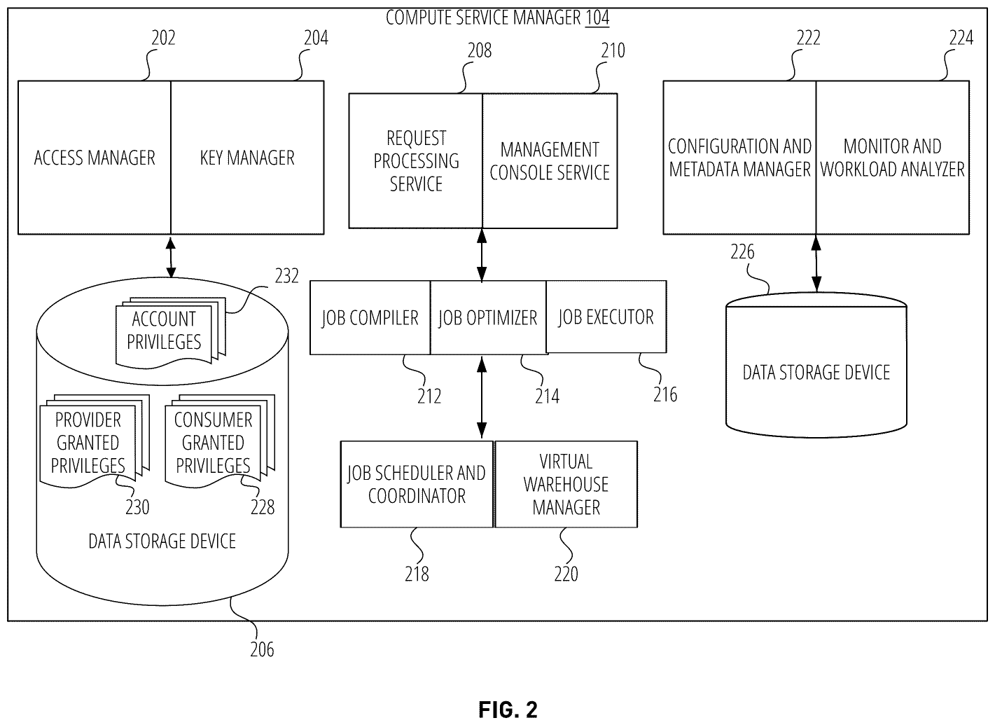

FIG. 2 is a block diagram illustrating components of the compute service manager 104, in accordance with some examples of the present disclosure. As shown in FIG. 2, the compute service manager 104 includes an access manager 202 and a key manager 204 coupled to a data storage device 206. Access manager 202 handles authentication and authorization tasks for the systems described herein. Key manager 204 manages storage and authentication of keys used during authentication and authorization tasks. For example, access manager 202 and key manager 204 manage the keys used to access data stored in remote storage devices (e.g., data storage devices in data storage 106). As used herein, the remote storage devices may also be referred to as “persistent storage devices” or “shared storage devices.”

In some examples, the access manager 202 authorizes access to database objects of the data platform 102 based on one or more sets of access privileges stored on the data storage device 206, such as a set of account privileges 232, a set of provider granted privileges 230, and a set of consumer granted privileges 228.

A request processing service 208 manages received data storage requests and data retrieval requests (e.g., jobs to be performed on database data). For example, the request processing service 208 may determine the data necessary to process a received query (e.g., a data storage request or data retrieval request). The data may be stored in a cache within the execution platform 110 or in a data storage device in data storage 106.

A management console service 210 supports access to various systems and processes by administrators and other system managers. Additionally, the management console service 210 may receive a request to execute a job and monitor the workload on the system.

The compute service manager 104 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. The job optimizer 214 also handles various data pruning operations and other data optimization techniques to improve the speed and efficiency of executing the job. The job executor 216 executes the execution code for jobs received from a queue or determined by the compute service manager 104.

A job scheduler and coordinator 218 sends received jobs to the appropriate services or systems for compilation, optimization, and dispatch to the execution platform 110. For example, jobs may be prioritized and processed in that prioritized order. In some examples, the job scheduler and coordinator 218 determines a priority for internal jobs that are scheduled by the compute service manager 104 with other “outside” jobs such as user queries that may be scheduled by other systems in the database but may utilize the same processing resources in the execution platform 110. In some examples, the job scheduler and coordinator 218 identifies or assigns particular nodes in the execution platform 110 to process particular tasks. A virtual warehouse manager 220 manages the operation of multiple virtual warehouses implemented in the execution platform 110. As discussed below, each virtual warehouse includes multiple execution nodes that each include a cache and a processor.

Additionally, the compute service manager 104 includes a configuration and metadata manager 222, which manages the information related to the data stored in the remote data storage devices and in the local caches (e.g., the caches in execution platform 110). The configuration and metadata manager 222 uses the metadata to determine which data micro-partitions need to be accessed to retrieve data for processing a particular task or job. A monitor and workload analyzer 224 oversees processes performed by the compute service manager 104 and manages the distribution of tasks (e.g., workload) across the virtual warehouses and execution nodes in the execution platform 110. The monitor and workload analyzer 224 also redistributes tasks, as needed, based on changing workloads throughout the data platform 102 and may further redistribute tasks based on a user (e.g., “external”) query workload that may also be processed by the execution platform 110. The configuration and metadata manager 222 and the monitor and workload analyzer 224 are coupled to a data storage device 226. Data storage device 226 in FIG. 2 represents any data storage device within the data platform 102. For example, data storage device 226 may represent caches in execution platform 110, storage devices in data storage 106, or any other storage device.

The compute service manager 104 validates all communication from an execution platform (e.g., the execution platform 110) to validate that the content and context of that communication are consistent with the task(s) known to be assigned to the execution platform. For example, an instance of the execution platform executing a query A should not be allowed to request access to data-source D (e.g., data storage device 226) that is not relevant to query A. Similarly, a given execution node (e.g., execution node 1 304a) may need to communicate with another execution node (e.g., execution node 2 304b), and should be disallowed from communicating with a third execution node (e.g., execution node 1 316a) and any such illicit communication can be recorded (e.g., in a log or other location). Also, the information stored on a given execution node is restricted to data relevant to the current query and any other data is unusable, rendered so by destruction or encryption where the key is unavailable.

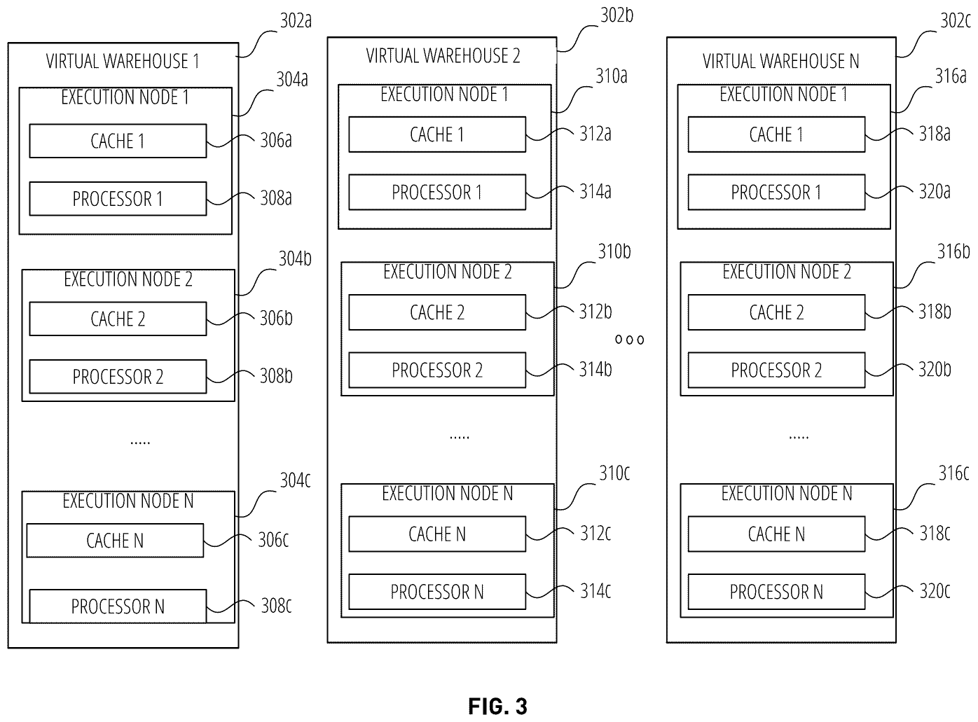

FIG. 3 is a block diagram illustrating components of the execution platform 110, in accordance with some examples of the present disclosure. As shown in FIG. 3, the execution platform 110 includes multiple virtual warehouses, including virtual warehouse 1 302a, and virtual warehouse 2 302b to virtual warehouse N 302c. Each virtual warehouse includes multiple execution nodes that each includes a data cache and a processor. The virtual warehouses can execute multiple tasks in parallel by using the multiple execution nodes. As discussed herein, the execution platform 110 can add new virtual warehouses and drop existing virtual warehouses in real time based on the current processing needs of the systems and users. This flexibility allows the execution platform 110 to quickly deploy large amounts of computing resources when needed without being forced to continue paying for those computing resources when they are no longer needed. All virtual warehouses can access data from any data storage device (e.g., any storage device in data storage 106).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary.

Each virtual warehouse is capable of accessing any of the data storage devices 1 to N shown in FIG. 1. Thus, the virtual warehouses are not necessarily assigned to a specific data storage device 1 to N and, instead, can access data from any of the data storage devices 1 to N within the data storage 106. Similarly, each of the execution nodes shown in FIG. 3 can access data from any of the data storage devices 1 to N. In some examples, a particular virtual warehouse or a particular execution node may be temporarily assigned to a specific data storage device, but the virtual warehouse or execution node may later access data from any other data storage device.

In the example of FIG. 3, virtual warehouse 1 302a includes a plurality of execution nodes as exemplified by execution node 1 304a, execution node 2 304b, and execution node N 304c. Execution node 1 304a includes cache 1 306a and a processor 1 308a. Execution node 2 304b includes cache 2 306b and processor 2 308b. Execution node N 304c includes cache N 306c and processor N 308c. Each execution node 1 to N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 302a discussed above, virtual warehouse 2 302b includes a plurality of execution nodes as exemplified by execution node 1 310a, execution node 2 310b, and execution node N 310c. Execution node 1 304a includes cache 1 312a and processor 1 314a. Execution node 2 310b includes cache 2 312b and processor 2 314b. Execution node N 310c includes cache N 312c and processor N 314c. Additionally, virtual warehouse N 302c includes a plurality of execution nodes as exemplified by execution node 1 316a, execution node 2 316b, and execution node N 316c. Execution node 1 316a includes cache 1 318a and processor 1 320a. Execution node 2 316b includes cache 2 318b and processor 2 320b. Execution node N 316c includes cache N 318c and processor N 320c.

In some examples, the execution nodes shown in FIG. 3 are stateless with respect to the data the execution nodes are caching. For example, these execution nodes do not store or otherwise maintain state information about the execution node or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each includes one data cache and one processor, alternate examples may include execution nodes containing any number of processors and any number of caches. Additionally, the caches may vary in size among the different execution nodes. The caches shown in FIG. 3 store, in the local execution node, data that was retrieved from one or more data storage devices in data storage 106. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some examples, the caches are implemented using high-speed memory devices that provide fast access to the cached data. Each cache can store data from any of the storage devices in the data storage 106.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, useful for tasks that require fast scanning of large amounts of data. In some examples, the cache resources and computing resources associated with a particular execution node are determined when the execution node is created, based on the expected tasks to be performed by the execution node.

Additionally, the cache resources and computing resources associated with a particular execution node may change over time based on changing tasks performed by the execution node. For example, an execution node may be assigned more processing resources if the tasks performed by the execution node become more processor-intensive. Similarly, an execution node may be assigned more cache resources if the tasks performed by the execution node require a larger cache capacity.

Although virtual warehouses 1, 2, and N are associated with the same execution platform 110, the virtual warehouses may be implemented using multiple computing systems at multiple geographic locations. For example, virtual warehouse 1 can be implemented by a computing system at a first geographic location, while virtual warehouses 2 and N are implemented by another computing system at a second geographic location. In some examples, these different computing systems are cloud-based computing systems maintained by one or more different entities.

Additionally, each virtual warehouse as shown in FIG. 3 has multiple execution nodes. The multiple execution nodes associated with each virtual warehouse may be implemented using multiple computing systems at multiple geographic locations. For example, an instance of virtual warehouse 1 302a implements execution node 1 304a and execution node 2 304b on one computing platform at a geographic location and implements execution node N 304c at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

A particular execution platform 110 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer necessary.

In some examples, the virtual warehouses may operate on the same data in data storage 106, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

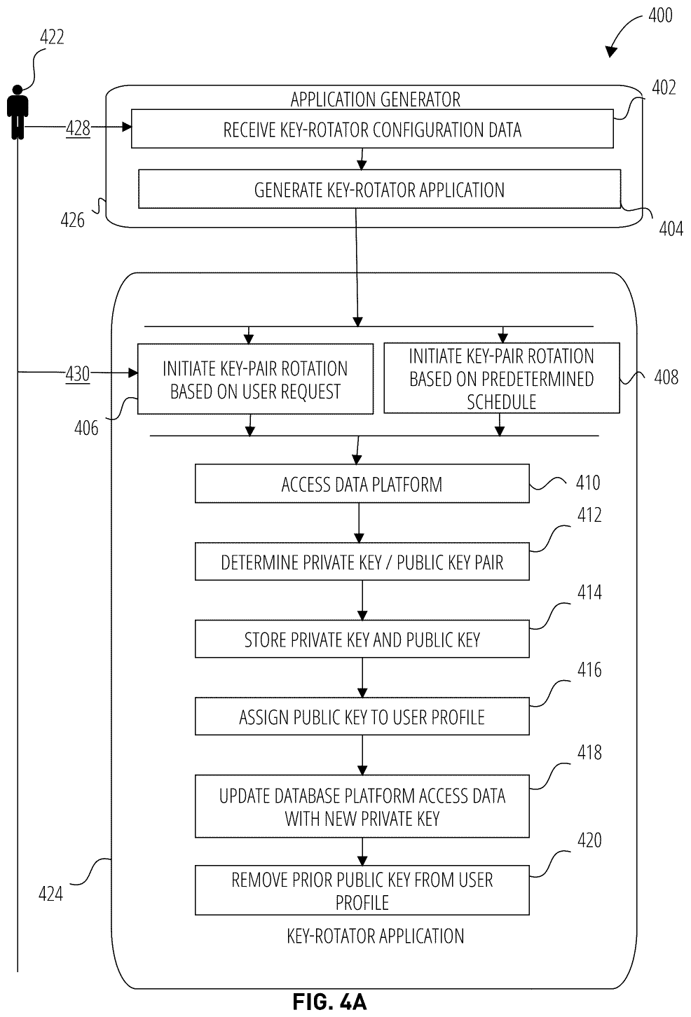

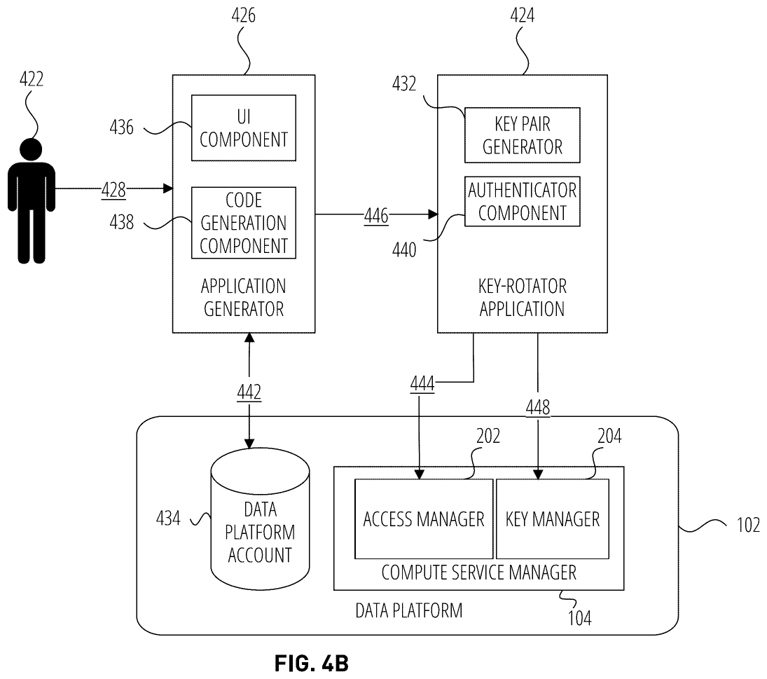

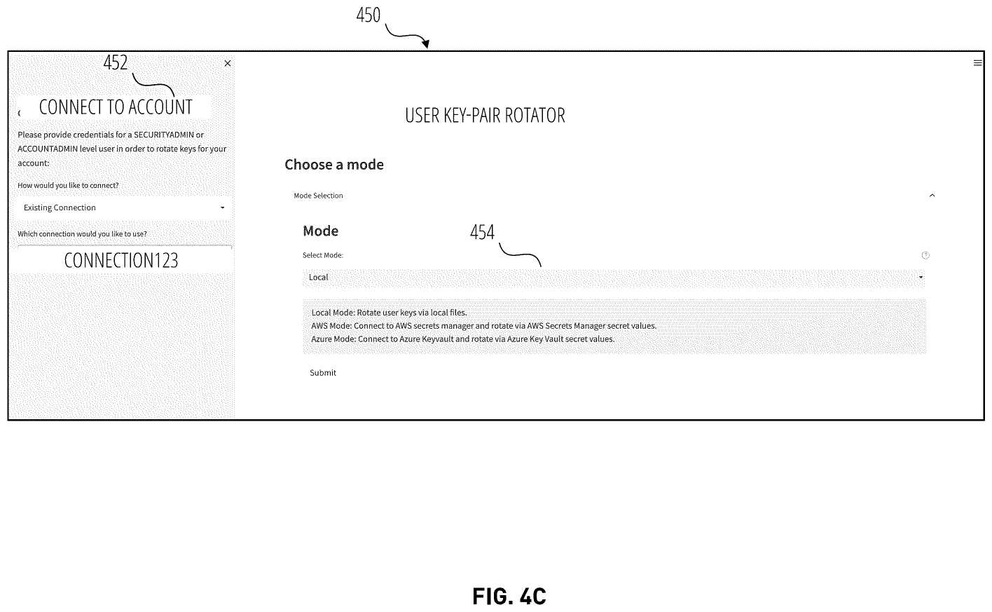

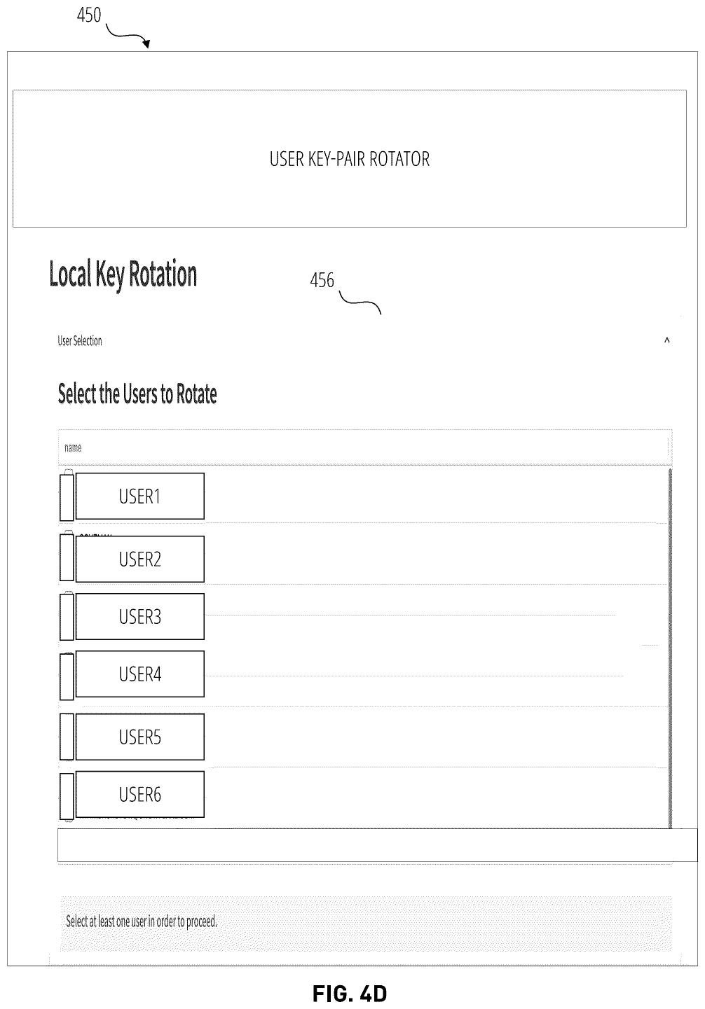

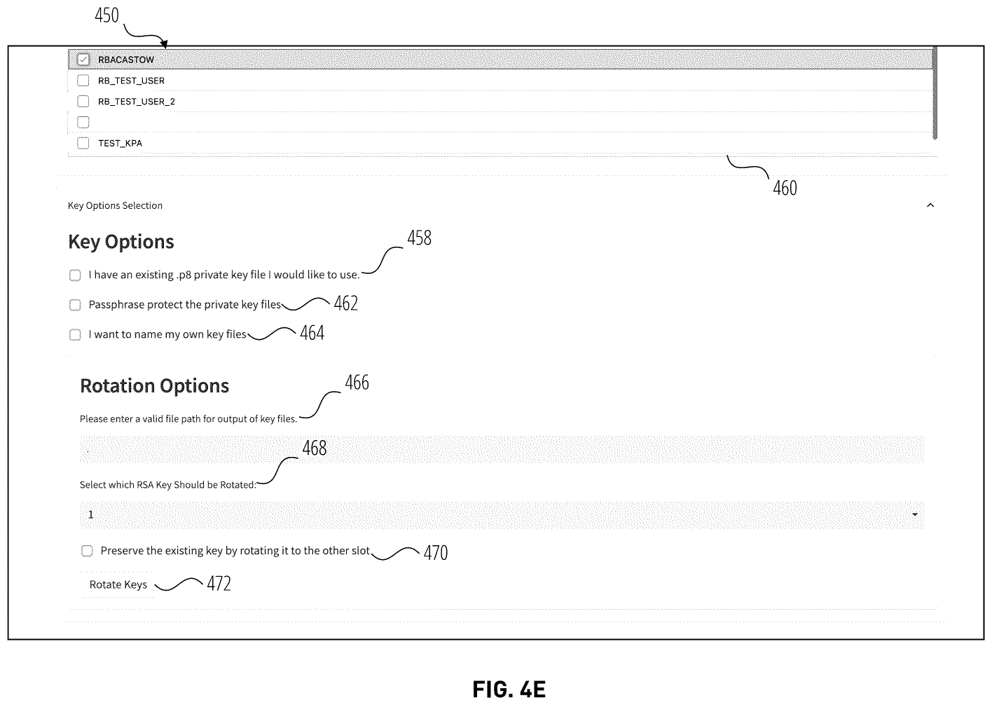

FIG. 4A is a process flow diagram illustrating a key-rotation management method 400, FIG. 4B is an illustration of a computational environment of the key-rotation management method 400, and FIG. 4C, FIG. 4D, and FIG. 4E illustrate portions of a key-rotation application configuration user interface in accordance with some examples. A database administrator 422 uses the key-rotation management method 400 to configure a key-rotator application 424 to rotate private/public key pairs (key pairs) used in security processes of a data platform 102.

The application generator 426 comprises a User Interface (UI) component 436 used to provide a user interface to the database administrator 422. The UI component 436 receives key-rotator application configuration instructions 428 from the database administrator 422. A code generation component 438 of the application generator 426 generates application code 446 of a key-rotator application 424 based on the key-rotator application configuration instructions 428 and account data 442 of a data platform account 434 of a data platform 102.

In operation 402, an application generator 426 provides a key-rotation application configuration user interface 450 to a database administrator 422. The compute service manager 104 receives key-rotator application configuration instructions 428 from the database administrator 422 as the database administrator 422 interacts with portions of the key-rotation application configuration user interface 450. The application generator 426 uses a code generation component 438 to generate application code 446 of a key-rotator application 424 based on the key-rotator application configuration instructions 428 and on account data 442 of a data platform account 434 of a data platform 102.

For example, the application generator 426 receives account identification data provided by the database administrator 422 via the account identification field 452 of the key-rotation application configuration user interface 450. The application generator 426 uses the account identification data to access a data platform account 434 on the data platform 102 and obtain account data 442 used to provide additional features of the key-rotation application configuration user interface 450.

The application generator 426 receives data platform identification data from the database administrator 422 via a data platform selector 454 (of FIG. 4C) of the key-rotation application configuration user interface 450. The compute service manager 104 uses the data platform identification data to configure the key-rotator application 424 to access the data platform 102. In some examples, the application generator 426 generates a key-rotator application 424 that access a local data platform that is associated with the application generator 426. In some examples, the application generator 426 generates a key-rotator application 424 for a 3rd party data platform.

The compute service manager 104 accesses a data platform account 434 based on the data platform identification data and the account identification data and receives account data 442 from the accessed data platform 102. The account data 442 includes user profile data of one or more users associated with the data platform 102. The user profile data includes data about users who are authorized by the database administrator 422 to access the data platform 102 using the data platform account 434.

The application generator 426 generates a user selector 456 (of FIG. 4D) of the key-rotation application configuration user interface 450 based on the account user profile data and provides the user selector 456 to the user. The compute service manager 104 receives user profile identification data from the database administrator 422 via the user selector 456 of the key-rotation application configuration user interface 450. The user profile identification data identifies a user profile of a user whose key pairs used to access the data platform will be rotated by the key-rotator application 424.

In some examples, a user will have two or more user profiles on a data platform. In response to detecting two or more user profiles associated with a user, the application generator 426 provides a user account selector 460 (of FIG. 4E). The application generator 426 receives additional user profile data via the user account selector 460 of the key-rotation application configuration user interface 450.

The application generator 426 receives key pair source data from the database administrator 422 via a key pair source selector 458 (of FIG. 4E). The application generator 426 configures the key-rotator application 424 to use user supplied key pairs or to automatically generate key pairs during a key-rotation process based on the key pair source data.

The application generator 426 receives key passphrase data from the database administrator 422 via a passphrase mode selector 462 (of FIG. 4E). The application generator 426 configures the key-rotator application 424 to use or not to use passphrases to store and recall key pairs based on the key passphrase data.

The compute service manager 104 receives key naming data from the database administrator 422 via a key naming selector 464 (of FIG. 4E). The application generator 426 configures the key-rotator application 424 to use user entered key pair names or to automatically generate key pair names based on the key naming data.

The application generator 426 receives key pair file path data from the database administrator 422 via a file path field 466. The application generator 426 configures the key-rotator application 424 to output key pairs to a file specified by the key pair file path data.

The application generator 426 receives key pair identification data a from the database administrator 422 via a key to rotate selector 468. The application generator 426 configures the key-rotator application 424 to rotate a key pair based on the key pair identification data.

The compute service manager 104 receives key pair preservation data from the database administrator 422 via a key preservation selector 470 (of FIG. 4E). The application generator 426 configures the key-rotator application 424 to preserve a key pair and reuse it for another account based on the key pair preservation data.

The application generator 426 receives key-rotation request data from the database administrator 422 via a key rotation request selector 472 (of FIG. 4E). The application generator 426 executes the key-rotator application 424 based on the key-rotation request data.

In operation 404, the application generator 426 uses a code generation component 438 to generate the application code 446 of the key-rotator application 424 based on the key-rotator application configuration instructions 428 received from the database administrator 422 and the account data 442 received from the data platform 102. For example, the code generation component 438 includes one or more code templates in a programming language such as, but not limited to, Python. The one or more code templates include fields for variables whose values are included in the key-rotator application configuration instructions 428 received by the application generator 426 from the database administrator 422. For instance, a portion of a code template for opening a connection to the data platform 102 may include the Python code “ctx=platform.connector.connect(user=′<user>′, account=′<account identifier>′, private key=pkb, warehouse=WAREHOUSE, database=DATABASE, schema=SCHEMA)” where “user” is a variable for a user name associated with user profile and <user> is a field in the template that is populated based on user profile data received from the data platform account 434 as part of account data 442. To generate the application code 446, the application generator 426 selects one or more code templates and populates the data fields of the one or more code templates based on the key-rotator application configuration instructions 428 and the account data 442. The application generator 426 combines the one or more populated code templates to generate the application code 446 of the key-rotator application 424.

In some examples, the key-rotator application 424 comprises an authenticator component 440 that authenticates the key-rotator application 424 to the data platform 102 by communicating authentication data 444 to an access manager 202 of the data platform 102. The key-rotator application 424 also comprises a key pair generator 432 that the key-rotator application 424 uses to generate to generate private/public key pairs (key pairs) used in one or more authorization processes by the data platform 102 in a process. In some examples, the key-rotator application 424 comprises a Python script that uses Python objects from a connector class to access a data platform. In some examples, the key-rotator application 424 is run by a client device, such as client device 112. In some examples, the key-rotator application 424 is run by a server or other automated data processing system.

Running of the key-rotator application 424 to perform a key-rotation process may be initiated in a variety of ways. In operation 406, the key-rotator application 424 receives key-rotation request data 430 from a user and initiates key-rotation in response to receiving the request. In another mode, in operation 408, running of the key-rotator application 424 is initiated based on a predetermined schedule.

In operation 410, the key-rotator application 424 generates authentication data 444 communicated to an access manager 202 of the data platform 102 based on the data platform identification data and the user profile data. In some examples, when the key-rotator application 424 comprises Python code, the following code may be used:

import platform.connector
import os from cryptography.hazmat.backends
import default_backend from cryptography.hazmat.primitives.asymmetric
import rsa from cryptography.hazmat.primitives.asymmetric
import dsa from cryptography.hazmat.primitives
import serialization with open(“<path>/rsa_key.p8”, “rb”) as key:
p_key= serialization.load_pem_private_key(key.read( ),
password=os.environ[‘PRIVATE_KEY_PASSPHRASE’].encode( ),
backend=default_backend( ))pkb = p_key.private_bytes(
encoding=serialization.Encoding.DER,
format=serialization.PrivateFormat.PKCS8,
encryption_algorithm = serialization.NoEncryption( ))
ctx =
platform.connector.connect(user=‘<user>’,account=‘<account_identifier
>’,private_key=pkb,
warehouse=WAREHOUSE,database=DATABASE,schema=SCHEMA)cs
= ctx.cursor( )

In operation 412, the key-rotator application 424 determines a private key/public key. In response to determining that a pre-computed key pair exists in a specified file, the key-rotator application 424 recalls the key pair from the specified file. In some examples, in response to determining that the pre-computed key pair is not stored in a suitable or specified data format, the key-rotator application 424 translates the pre-computed stored key pair into a suitable format. For example, the key-rotator application 424 determines the file format of the pre-computed stored key pair from file metadata. The key-rotator application 424 compares the file format of the pre-computed stored key pair to a specified format. If the file format of the pre-computed stored key pair is not of the specified format, the key-rotator application 424 performs a file translation based on the file format of the pre-computed stored key pair and the specified format.

In response to determining that a pre-computed key pair does not exist in a specified file, the key-rotator application 424 generates a new key pair. For example, when the key-rotator application 424 comprises a script, the following command line command is executed to generate a private key with no encryption:

openssl genrsa 2048 | openssl pkcs8 -topk8 -inform PEM -out
rsa_key.p8 -nocrypt

and the following command can be used to generate an encrypted private key

$ openssl genrsa 2048 | openssl pkcs8 -topk8 -v2 des3 -inform PEM -
out rsa_key.p8

In some examples, to generate a public key, the key-rotator application 424 executes a command line command comprising:
$ openssl rsa -in rsa_key.p8 -pubout -out rsa_key.pub

In some examples, a key-rotator application 424 is implemented in a programming language and uses primitives from a cryptography library to generate keys as illustrated in the following code:

```
private_key = rsa.generate_private_key(public_exponent=65537,
key_size=2048)
encrypted_private_key = private_key.private_bytes(
  encoding=serialization.Encoding.PEM,
  format=serialization.PrivateFormat.PKCS8,
encryption_algorithm=serialization.BestAvailableEncryption(passphrase)
  if passphrase
  else serialization.NoEncryption( ),
)
public_key = private_key.public_key( ).public_bytes(
  encoding=serialization.Encoding.PEM,
    format=serialization.PublicFormat.SubjectPublicKeyInfo,
)
In some examples, a key pair is generated with an encrypted or
unencrypted private key based on whether or not a password is provided to
encrypt the key. The decoded public key generated above is associated
with the user in the data platform 102 whereas the decoded encrypted
private key is stored locally or within a key manager 204.
```

In some examples, the key-rotator application 424 determines to apply a passphrase to the new key pair based on key passphrase data. For example, in response to determining that a passphrase is to be applied to the new key pair, the key-rotator application 424 encrypts the key pair before storing the key pair using a passphrase. In response to determining that a passphrase is not to be applied to the new key pair, the key-rotator application 424 does not apply a passphrase to the key pair.

In operation 414, the key-rotator application 424 stores the private key and the public key. In some examples, the key-rotator application 424 copies the public and private key files to a local directory for storage based on a request by the database administrator 422 where the request is included in the key-rotator application configuration instructions 428 and incorporated into the key-rotator application 424. In some examples, the private key and public key are encrypted using passphrase. In some examples, the key-rotator application 424 stores the key pair with a 3rd party data storage system that is optimized for security. In a case the database administrator 422 does not request that a key pair be stored locally, the key-rotator application 424 communicates the key pair to a key manager 204 of a data platform 102. In response, the key manager 204 associates the public key with the user within the data platform 102.

In operation 416, the key-rotator application 424 generates key-rotation instruction data 448 and communicates the key-rotation instruction data 448 to a key manager 204 of the data platform 102. The key-rotation instruction data 448 includes instructions instructing the key manager 204 to assign the public key to a user profile of the data platform account 434 based on the user profile data. For instance, the key-rotator application 424 may instruct the data platform 102 to execute a command such as:
alter user jsmith set rsa_public_key=‘MIIBIjANBgkqh . . . ’;

In some examples, the key-rotator application 424 is run under the permissions of a security administrator, thus allowing the key-rotator application 424 to alter a user profile. In some examples, the key-rotator application 424 establishes one or more connections to the data platform 102 with a specified role with permissions of a security administrator or database administrator, thus allowing the key-rotator application 424 to alter a user profile.

In operation 418, the key-rotator application 424 generates key-rotation instruction data 448 (of FIG. 4B) communicated to a key manager 204 of the data platform 102 to update database platform access data of one or more user profiles of the data platform account 434 with the new private key. For example, the key-rotator application 424 generates the key-rotation instruction data 448 including instructions to update a user's access to one or more services or drivers of the data platform 102 such as, but not limited to, a SQL service, a connector service, a driver, and the like.

In block 420, the key-rotator application 424 generates key-rotation instruction data 448 instructing the key manager 204 to remove a prior public key from the user profile. In some examples, the key-rotator application 424 preserves the prior key pair for reuse in another user profile associated with the user or another user.

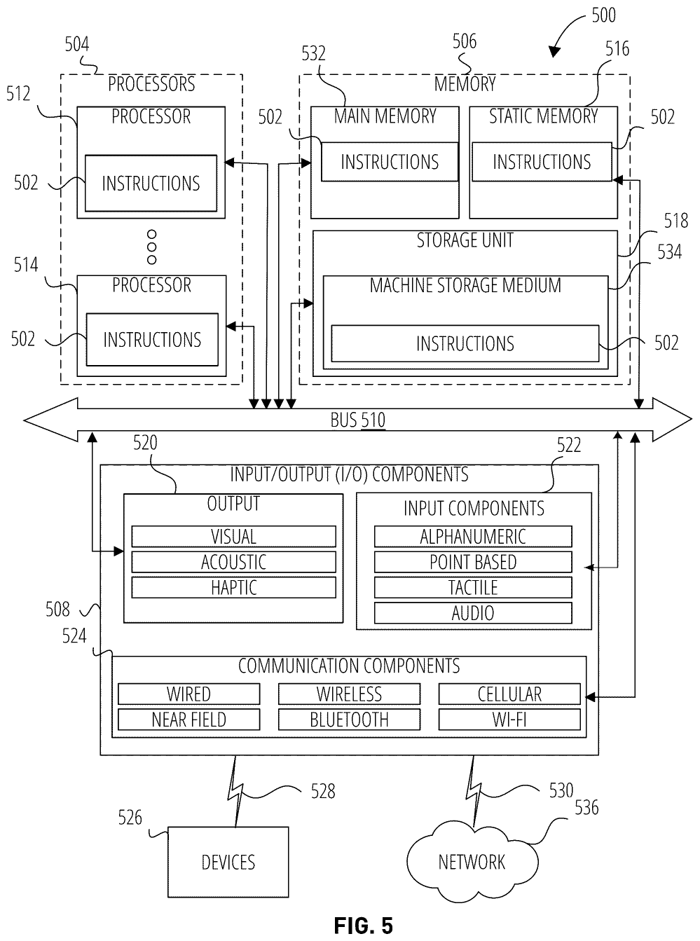

FIG. 5 illustrates a diagrammatic representation of a machine 500 in the form of a computer system within which a set of instructions may be executed for causing the machine 500 to perform any one or more of the methodologies discussed herein, according to examples. Specifically, FIG. 5 shows a diagrammatic representation of the machine 500 in the example form of a computer system, within which instructions 502 (e.g., software, a program, an application, an applet, a data application, or other executable code) for causing the machine 500 to perform any one or more of the methodologies discussed herein may be executed. For example, the instructions 502 may cause the machine 500 to execute any one or more operations of any one or more of the methods described herein. In this way, the instructions 502 transform a general, non-programmed machine into a particular machine 500 (e.g., the compute service manager 104, the execution platform 110, and the data storage devices 1 to N of data storage 106) that is specially configured to carry out any one of the described and illustrated functions in the manner described herein.

In alternative examples, the machine 500 operates as a standalone device or may be coupled (e.g., networked) to other machines. In a networked deployment, the machine 500 may operate in the capacity of a server machine or a client machine in a server-client network environment, or as a peer machine in a peer-to-peer (or distributed) network environment. The machine 500 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 502, sequentially or otherwise, that specify actions to be taken by the machine 500. Further, while only a single machine 500 is illustrated, the term “machine” shall also be taken to include a collection of machines that individually or jointly execute the instructions 502 to perform any one or more of the methodologies discussed herein.

The machine 500 includes processors 504, memory 506, and I/O components 508 configured to communicate with each other such as via a bus 510. In some examples, the processors 504 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, multiple processors as exemplified by processor 512 and a processor 514 that may execute the instructions 502. The term “processor” is intended to include multi-core processors that may comprise two or more independent processors (sometimes referred to as “cores”) that may execute instructions 502 contemporaneously. Although FIG. 5 shows multiple processors 504, the machine 500 may include a single processor with a single core, a single processor with multiple cores (e.g., a multi-core processor), multiple processors with a single core, multiple processors with multiple cores, or any combination thereof.

The memory 506 may include a main memory 532, a static memory 516, and a storage unit 518 including a machine storage medium 534, all accessible to the processors 504 such as via the bus 510. The main memory 532, the static memory 516, and the storage unit 518 store the instructions 502 embodying any one or more of the methodologies or functions described herein. The instructions 502 may also reside, completely or partially, within the main memory 532, within the static memory 516, within the storage unit 518, within at least one of the processors 504 (e.g., within the processor's cache memory), or any suitable combination thereof, during execution thereof by the machine 500.

The input/output (I/O) components 508 include components to receive input, provide output, produce output, transmit information, exchange information, capture measurements, and so on. The specific I/O components 508 that are included in a particular machine 500 will depend on the type of machine. For example, portable machines such as mobile phones will likely include a touch input device or other such input mechanisms, while a headless server machine will likely not include such a touch input device. It will be appreciated that the I/O components 508 may include many other components that are not shown in FIG. 5. The I/O components 508 are grouped according to functionality merely for simplifying the following discussion and the grouping is in no way limiting. In various examples, the I/O components 508 may include output components 520 and input components 522. The output components 520 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 522 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 508 may include communication components 524 operable to couple the machine 500 to a network 536 or devices 526 via a coupling 530 and a coupling 528, respectively. For example, the communication components 524 may include a network interface component or another suitable device to interface with the network 536. In further examples, the communication components 524 may include wired communication components, wireless communication components, cellular communication components, and other communication components to provide communication via other modalities. The devices 526 may be another machine or any of a wide variety of peripheral devices (e.g., a peripheral device coupled via a universal serial bus (USB)). For example, as noted above, the machine 500 may correspond to any one of the compute service manager 104, the execution platform 110, and the devices 526 may include the data storage device 226 or any other computing device described herein as being in communication with the data platform 102 or the data storage 106.

The various memories (e.g., 506, 516, 532, and/or memory of the processor(s) 504 and/or the storage unit 518) may store one or more sets of instructions 502 and data structures (e.g., software) embodying or utilized by any one or more of the methodologies or functions described herein. These instructions 502, when executed by the processor(s) 504, cause various operations to implement the disclosed examples.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various examples, one or more portions of the network 536 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 536 or a portion of the network 536 may include a wireless or cellular network, and the coupling 530 may be a Code Division Multiple Access (CDMA) connection, a Global System for Mobile communications (GSM) connection, or another type of cellular or wireless coupling. In this example, the coupling 530 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, fifth generation wireless (5G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 502 may be transmitted or received over the network 536 using a transmission medium via a network interface device (e.g., a network interface component included in the communication components 524) and utilizing any one of a number of well-known transfer protocols (e.g., hypertext transfer protocol (HTTP)). Similarly, the instructions 502 may be transmitted or received using a transmission medium via the coupling 528 (e.g., a peer-to-peer coupling) to the devices 526. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 502 for execution by the machine 500, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the methodologies disclosed herein may be performed by one or more processors. The performance of certain of the operations may be distributed among the one or more processors, not only residing within a single machine, but also deployed across a number of machines. In some examples, the processor or processors may be located in a single location (e.g., within a home environment, an office environment, or a server farm), while in other examples the processors may be distributed across a number of locations.

Although the examples of the present disclosure have been described with reference to specific examples, it will be evident that various modifications and changes may be made to these examples without departing from the broader scope of the inventive subject matter. Accordingly, the specification and drawings are to be regarded in an illustrative rather than a restrictive sense. The accompanying drawings that form a part hereof show, by way of illustration, and not of limitation, specific examples in which the subject matter may be practiced. The examples illustrated are described in sufficient detail to enable those skilled in the art to practice the teachings disclosed herein. Other examples may be used and derived therefrom, such that structural and logical substitutions and changes may be made without departing from the scope of this disclosure. This Detailed Description, therefore, is not to be taken in a limiting sense, and the scope of various examples is defined only by the appended claims, along with the full range of equivalents to which such claims are entitled.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

Such examples of the inventive subject matter may be referred to herein, individually and/or collectively, by the term “example” merely for convenience and without intending to voluntarily limit the scope of this application to any single invention or inventive concept if more than one is in fact disclosed. Thus, although specific examples have been illustrated and described herein, it should be appreciated that any arrangement calculated to achieve the same purpose may be substituted for the specific examples shown. This disclosure is intended to cover any and all adaptations or variations of various examples. Combinations of the above examples, and other examples not specifically described herein, will be apparent to those of skill in the art, upon reviewing the above description.

What is claimed is:

1. A data platform comprising:
one or more processors; and
at least one memory storing instructions that cause the one or more processors to perform operations comprising:
receiving key-rotator application configuration instructions;
generating a key-rotator application based on the key key-rotator application configuration instructions;
initiating a key-rotation process using the key-rotation application based on a predetermined schedule, the key-rotation process comprising:
accessing the data platform based on an account identification of the key-rotator application configuration instructions;
determining a key pair comprising a private key and a public key;
assigning the public key to a user profile of the data platform, the user profile included in the key-rotator application configuration instructions;
updating one or more data platform services with the private key; and
deleting a prior public key from the user profile.

2. The data platform of claim 1, wherein determining the private key and the public key further comprises:
determining that a pre-computed key pair is stored in a specified file; and
in response to determining that the pre-computed key pair is not stored in a specified file format, performing a file translation of the pre-computed key pair based on the file format of the pre-computed key pair.

3. The data platform of claim 1, wherein determining a private key and public key further comprises:
determining that a pre-computed key pair is not stored in a specified file; and
in response to determining that the pre-computed key pair is not stored in the specified file generating the private key and the public key.

4. The data platform of claim 1, wherein the operations further comprise:
initiating the key-rotation process based on a received key-rotation request.

5. The data platform of claim 1, wherein accessing the data platform based on an account identification of the key-rotator application configuration instructions further comprises:
establishing one or more connections to the data platform with a specified role with permissions of a security administrator.

6. The data platform of claim 1, wherein the key-rotation process further comprises:
storing the private key and the public key in a datastore based on a the key-rotator application configuration instructions.

7. The data platform of claim 1, wherein the key-rotation process further comprises:
preserving a prior key for reuse.

8. A computer-implemented method of a data platform, the method comprising:
receiving key-rotator application configuration instructions;
generating a key-rotator application based on the key key-rotator application configuration instructions;
initiating a key-rotation process using the key-rotation application based on a predetermined schedule, the key-rotation process comprising:
accessing the data platform based on an account identification of the key-rotator application configuration instructions;
determining a key pair comprising a private key and a public key;
assigning the public key to a user profile of the data platform, the user profile included in the key-rotator application configuration instructions;
updating one or more data platform services with the private key; and
deleting a prior public key from the user profile.

9. The computer-implemented method of a data platform of claim 8, wherein determining the private key and the public key further comprises:
determining that a pre-computed key pair is stored in a specified file; and
in response to determining that the pre-computed key pair is not stored in a specified file format, performing a file translation of the pre-computed key pair based on the file format of the pre-computed key pair.

10. The computer-implemented method of a data platform of claim 8, wherein determining a private key and public key further comprises:
determining that a pre-computed key pair is not stored in a specified file; and
in response to determining that the pre-computed key pair is not stored in the specified file generating the private key and the public key.

11. The computer-implemented method of a data platform of claim 8, wherein the operations further comprise:
initiating the key-rotation process based on a received key-rotation request.

12. The computer-implemented method of a data platform of claim 8, wherein accessing the data platform based on an account identification of the key-rotator application configuration instructions further comprises:
establishing one or more connections to the data platform with a specified role with permissions of a security administrator.

13. The computer-implemented method of a data platform of claim 8, wherein the key-rotation process further comprises:
storing the private key and the public key in a datastore based on a the key-rotator application configuration instructions.

14. The computer-implemented method of a data platform of claim 8, wherein the key-rotation process further comprises:
preserving a prior key for reuse.

15. A computer-storage medium comprising instructions that, when executed by a computer, cause the computer to perform operations comprising:
receiving key-rotator application configuration instructions;
generating a key-rotator application based on the key key-rotator application configuration instructions;
initiating a key-rotation process using the key-rotation application based on a predetermined schedule, the key-rotation process comprising:
accessing a data platform based on an account identification of the key-rotator application configuration instructions;
determining a key pair comprising a private key and a public key;
assigning the public key to a user profile of the data platform, the user profile included in the key-rotator application configuration instructions;
updating one or more data platform services with the private key; and
deleting a prior public key from the user profile.

16. The computer-storage medium comprising instructions of claim 15, wherein determining the private key and the public key further comprises:
determining that a pre-computed key pair is stored in a specified file; and
in response to determining that the pre-computed key pair is not stored in a specified file format, performing a file translation of the pre-computed key pair based on the file format of the pre-computed key pair.

17. The computer-storage medium comprising instructions of claim 15, wherein determining a private key and public key further comprises:
determining that a pre-computed key pair is not stored in a specified file; and
in response to determining that the pre-computed key pair is not stored in the specified file generating the private key and the public key.

18. The computer-storage medium comprising instructions of claim 15, wherein the operations further comprise:
initiating the key-rotation process based on a received key-rotation request.

19. The computer-storage medium comprising instructions of claim 15, wherein accessing the data platform based on an account identification of the key-rotator application configuration instructions further comprises:
establishing one or more connections to the data platform with a specified role with permissions of a security administrator.

20. The computer-storage medium comprising instructions of claim 15, wherein the key-rotation process further comprises:
storing the private key and the public key in a datastore based on a the key-rotator application configuration instructions.
